(19) United States
(12) Patent Application Publication
(10) Pub. No.: US 2005/0144372 A1
(43) Pub. Date: Jun. 30, 2005

(54) Memory device controlled with user-defined commands

(76) Inventor: Robert Walker, Raleigh, NC (US)

Correspondence Address: EDELL, SHAPIRO, FINNAN & LYTLE, LLC, 1901 RESEARCH BOULEVARD, SUITE 400, ROCKVILLE, MD, 20850, US

(21) Appl. No.: 10/748,224

(22) Filed: Dec. 31, 2003

(51) Int. Cl. G06F 12/00

(52) U.S. Cl. 711/105; 711/156

(57) ABSTRACT

A memory device controllable with user-defined commands includes a memory array accessible for reading and writing data therein, a command module that receives user-defined commands for controlling access to the memory array, and a mode module that stores command definitions respectively associated with the user-defined commands. Each command definition includes a memory access command, such as a read command or a write command, and at least one memory access parameter, such as the burst length setting and the read or write latency. By sending a program command to the command module, command definitions of the user-defined commands can be programmed into the mode module. Each memory array access commanded by a user-defined command is controlled in accordance with the memory access parameters in the command definition associated with the user-defined command.

### BACKGROUND OF THE INVENTION

1. Field of the Invention

The present invention relates to techniques for accessing memory devices with user-defined commands.

2. Description of the Related Art

Memory devices are conventionally configured to permit reading and writing operations with a limited number of options. For example, a mode register associated with a memory array may maintain a set of memory access parameters such as the burst length, the read latency, the write latency, on die termination (enable/disabled), drive strength, impedance calibration, etc. Once the memory access parameters are set, a controller uses a fixed set of commands to instruct the memory device to perform operations, such as reading and writing, in accordance with the memory access parameters in the mode register. The manner in which the memory is accessed (e.g., with a certain burst length and read/write latencies) cannot be changed unless the memory access parameters in the mode register are reset. In addition to read and write commands, the command set typically includes a mode register set command that permits the contents of the mode register to be changed, so that the memory can be accessed with different parameters if necessary (e.g., in order to change the burst length).

Using this conventional approach, the flexibility in accessing the memory device is very limited without performing frequent mode register sets to change memory access parameters. Each time a mode register set command is needed to alter the stored memory access parameters, the memory device must essentially be reset by letting the pipeline of data clear out and resetting the mode register contents. This process may require several clock cycles before the memory device is again operational, making frequent resetting of the mode register contents time consuming and cumbersome.

Greater flexibility and more options for accessing a memory device would be advantageous in a variety of situations. Often, two or more processors share access to a memory device, such that the memory controller responsible for sending commands to the memory device must communicate with the processors and coordinate access to the memory device. When two processors, such as a processor and co-processor, have different techniques or algorithms for addressing the memory device, a dilemma exists, since the controller cannot be optimized for either the processor or the co-processor with a single, limited set of fixed commands. The command set does not provide enough flexibility to define how the memory access is to be set up in all circumstances and cannot be tailored for either processor. This situation is generally resolved by choosing a middle ground in the controller design that will allow support of both processors but that is not optimal for either processor. This compromise can result in controller complexity and the need to frequently reset the contents of the mode register during operation.

Another situation where greater memory access flexibility would be beneficial arises in the context of networking applications. When using a single input/output (SIO) mode of operation (i.e., where each pin is an input pin or an output pin, not both input and output), one-hundred percent bus utilization cannot be achieved with the lowest row cycle time (tRC) in a typical dynamic random access memory (DRAM) architecture while maintaining a balanced read/write pattern commonly found in networking applications.

An example illustrating a typical bus utilization sequence in a networking application is shown in the table of FIG. 1. In the example, successive read and write operations are executed to a sequence of memory banks using a low tRC, such as 20 ns. Specifically, in cycle 0, a read to bank 0 is performed, and in cycle 1, a write to bank 1 is performed. In cycle 2, a read to bank 2 is performed, and in cycle 3, a write to bank 3 is performed. Because of the requirements of the networking application, the next operation required is another write operation, in this case, to bank 0. Due to the limited flexibility of the command set, back-to-back write operations cannot be performed in consecutive cycles, and back-to-back read operations cannot be performed in consecutive cycles. Consequently, in cycle 4, a pause must occur before performing the next write operation in cycle 5 to bank 0. In cycles 6, 7 and 8, read, write and read operations to banks 1, 2 and 3 are performed, respectively. However, because the next operation is again a read operation, another pause must occur in cycle 9. Thus, while a minimum tRC is used in this example, only eighty percent bus utilization is achieved in this sequence. While SIO functionality is designed for high performance, the cost of implementation is high due to the dedicated write/read pins (i.e., better bandwidth can be achieved but at the penalty of having more pins). Consequently, it would be desirable for the SIO components to have one-hundred percent bus utilization at a minimum tRC.

### SUMMARY OF THE INVENTION

The present invention includes a memory device that is controllable with user-defined commands. Each user-defined command has certain memory access parameters associated with it, such as a particular burst length and the read/write latencies. To access the memory device with different memory access parameters, the controller need only select the appropriate user-defined command, thereby allowing the memory device to be accessed in a variety of different modes without having to alter the contents of a mode register.

In accordance with one aspect, a method of accessing a memory device using a plurality of user-defined commands includes: providing a set of commands for controlling access to the memory device, wherein the set of commands includes the plurality of user-defined commands; storing in the memory device a set of memory access parameters associated with each user-defined command, wherein each set of memory access parameters includes at least one memory access parameter; and accessing the memory device using the user-defined commands, wherein each memory access commanded by a user-defined command is controlled in accordance with the set of memory access parameters associated with the user-defined command. The memory access parameters can include, for example, a burst length setting, the read latency and/or the write latency. A command definition associated with each user-defined command, including the set of memory access parameters and a memory access command (e.g., read, write or terminate), can be stored in the memory device.

The set of commands can also include a program command for programming the user-defined commands into the memory device. The particular user-defined command to be programmed can be identified using an operational code associated with the program command. The operational code can be received via an address bus or data bus. The operational code can also be used to identify a non-programmable command to be executed in response to receiving the program command. For example, the non-programmable command can be an auto refresh command, a mode register set command, a no operation command, or a drive strength setting command.

In accordance with another aspect, a method of programming a memory device to support a plurality of user-defined commands includes: sending a program command from a controller to the memory device, wherein the program command indicates that a user-defined command is to be programmed in the memory device; sending an operational code associated with the program command from the controller to the memory device, wherein the operational code indicates which of the plurality of user-defined commands is to be programmed; sending a command definition from the controller to the memory device, wherein the command definition includes a memory access command and at least one memory access parameter; and storing the command definition in the memory device such that the command definition is associated with the user-defined defined command indicated by the operational code. The memory access command can be a read command, a write command, or a terminate command, for example, and the memory access parameters can include the burst length, the read latency and/or the write latency.

In accordance with another aspect, a method of accessing a memory device using a plurality of user-defined commands includes: providing a set of commands for controlling access to the memory device, wherein the set of commands includes the plurality of user-defined commands and a program command for programming the user-defined commands into the memory device; programming the user-defined commands by storing command definitions associated with the user-defined commands in the memory device in response to receipt of program commands, wherein each of the command definitions comprises a memory access command and a set of memory access parameters including a burst length and a read latency or a write latency; and accessing the memory device using the user-defined commands, wherein each memory access commanded by a user-defined command is controlled in accordance with the set of memory access parameters associated with the user-defined command. The method can further include sending with each program command an operational code, wherein the operational code includes a first set of bits that indicate which, if any, of the user-defined commands is to be programmed via the command definition and a second set of bits that indicate which, if any, of a set of non-programmable commands is to be executed. The set of non-programmable commands can include an auto refresh command, a mode register set command, a no operation command, and a drive strength setting command.

In accordance with yet another aspect, a method of accessing a memory device includes: providing a set of commands for controlling access to the memory device, wherein the set of commands includes a plurality of user-defined commands that are programmable in the memory device and at least one additional command for controlling the memory device with a non-programmable command; accessing the memory device using the user-defined commands, wherein each memory access commanded by a user-defined command is controlled in accordance with a set of memory access parameters associated with the user-defined command; and executing a non-programmable command in response to receipt of the at least one additional command, wherein the non-programmable command is specified in an operational code received in connection with the at least one additional command. The non-programmable command can be for example, an auto refresh command, a mode register set command, a no operation command, or a drive strength setting command.

In accordance with still another aspect, a memory device controllable with user-defined commands includes: a memory array accessible for reading and writing data therein; a command module that receives commands for controlling access to the memory array, wherein a set of commands for controlling access to the memory array includes a plurality of user-defined commands; and a mode module that stores command definitions respectively associated with the user-defined commands, wherein each command definition includes a memory access command and at least one memory access parameter, and wherein each memory array access commanded by a user-defined command is controlled in accordance with the at least one memory access parameter in the command definition associated with the user-defined command. The memory access command can be a read command, a write command, or a terminate command, and the memory access parameters can include a burst length, a read latency, and/or a write latency.

The memory device can further include a memory array control module, coupled to the memory array, that receives memory access commands from the mode module in response to receipt of a user-defined command, wherein the memory array control module controls access to the memory array in accordance with the memory access parameters associated with the user-defined command. The memory device can also include an address latch/counter module that receives an input address associated with a user-defined command and supplies addresses to the memory array control module during memory access in accordance with the memory access parameters associated with the user-defined command.

The set of commands can further include a program command for programming the user-defined commands into the mode module, wherein the command module commands the mode module to program a user-defined command in response to receipt of the program command. The command module can command the mode module to program a user-defined command specified by an operational code received via an address bus or data bus in connection with the program command. The set of commands can further include an additional command (which can be the program command) for controlling the memory device with a non-programmable command. The non-programmable command can be specified in an operational code received by the command module in connection with the additional command and can be, for example, an auto refresh command, a mode register set command, a no operation command, or a drive strength setting command.

According to another aspect, a memory device controllable with user-defined commands includes: means for storing data that is accessible for reading and writing data therein; means for processing input commands for controlling access to the means for storing data, wherein a set of commands for controlling access to the means for storing data includes a plurality of user-defined commands; and means for storing command definitions respectively associated with the user-defined commands, wherein each command definition includes a memory access command and at least one memory access parameter, and wherein each memory array access commanded by a user-defined command is controlled in accordance with the at least one memory access parameter in the command definition associated with the user-defined command. The memory access command can be a read command, a write command, or a terminate command, and the memory access parameters can include a burst length, the read latency and/or the write latency.

The memory device can further include means for controlling the means for storing data, that receives memory access commands from the means for storing command definitions in response to receipt of a user-defined command, wherein the means for controlling the means for storing data controls access to the means for storing data in accordance with the memory access parameters associated with the user-defined command.

The set of commands can further include a program command for programming the user-defined commands into the means for storing command definitions, wherein the means for processing input commands can command the means for storing command definitions to program a user-defined command in response to receipt of the program command. The means for processing input commands can command the means for storing command definitions to program a user-defined command specified by an operational code received via an address bus or a data bus in connection with the program command. The set of commands can further include an additional command (which can be the program command) for controlling the memory device with a non-programmable command. The non-programmable command can be specified in an operational code received by the means for processing input commands in connection with the additional command, and can be, for example, an auto refresh command, a mode register set command, a no operation command, or a drive strength setting command.

According to yet another aspect, a controller for controlling a memory device includes: a memory management module that manages access to the memory device; and a command generator module that generates commands for accessing the memory module in accordance with the memory management module, wherein the commands include a plurality of user-defined commands and a program command for programming the user-defined commands into the memory device, and wherein the controller sends to the memory device a command definition associated with a user-defined command to be programmed, the command definition including a memory access command and at least one memory access parameter. The controller can send to the memory device an operational code indicating which user-defined command is to be programmed in connection with a program command. The memory access command can be a read command, a write command, or a terminate command, and the memory access parameters can include the burst length, the read latency and/or the write latency.

The above and still further features and advantages of the present invention will become apparent upon consideration of the following definitions, descriptions and descriptive figures of specific embodiments thereof wherein like reference numerals in the various figures are utilized to designate like components. While these descriptions go into specific details of the invention, it should be understood that variations may and do exist and would be apparent to those skilled in the art based on the descriptions herein.

### BRIEF DESCRIPTION OF THE DRAWINGS

FIG. 1 is a table illustrating a sequence of cycles in which eighty percent bus utilization is achieved.

FIG. 2 is a block diagram of a memory device configured to operate with a conventional command set.

FIG. 3 is a block diagram of a memory device configured to operate with a user-defined set of encoded commands.

FIG. 4 is a functional flow diagram illustrating a process for operating the memory device shown in FIG. 3.

FIG. 5 is a table illustrating an example of a command set for implementing operation of the memory device shown in FIG. 3 with user-defined encoded commands.

FIG. 6 is a table illustrating an example of the use of the bits of an address word as a program command that extends the basic command set and triggers programming of user-defined commands.

FIG. 7 is a table illustrating an example of encoding address bits associated with a mode register set (MRS) command in a single cycle MRS command or a two cycle MRS command.

FIG. 8 is a table illustrating an example of a command definition in which encoded commands are assigned to particular bits of an address for loading user-defined commands in a mode module.

FIG. 9 is a table illustrating an example of encoding four bits with read latency settings or write latency settings.

FIG. 10 is a table illustrating an example of encoding four bits with burst length settings.

FIG. 11 is a table illustrating an example of encoding four bits with read, write and terminate command settings.

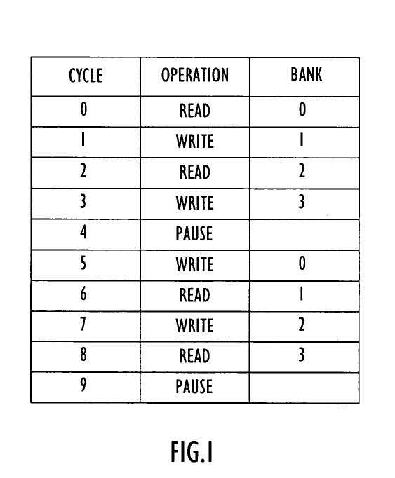

### DETAILED DESCRIPTION

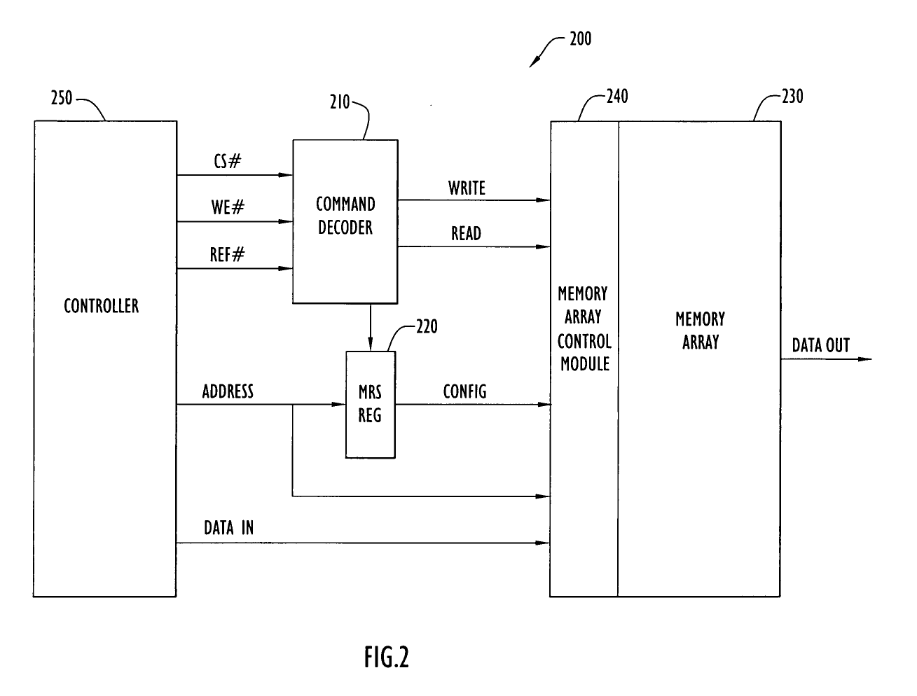

A memory device 200 configured to operate with a conventional set of controller commands is shown in FIG. 2. Memory device 200 includes a command decoder 210, a mode register set (MRS) register 220, and a memory array 230. Coupled to memory array 230 is a resident control module 240 for processing the write and read commands from command decoder 210 in accordance with configuration settings received from MRS register 220. Command decoder 210 receives operational commands from a controller 250 in the form of three control bits: CS# (chip select), WE# (write enable), and REF# (refresh), where combinations of the values of these control bits correspond to particular commands. Memory array control module 240 receives address information for reading and writing via an address input and receives data to be written to memory array 230 via a data input. Data read from memory array 230 is supplied on a data output.

Command decoder 210 essentially decodes the values of the input control bits to determine the command being sent from controller 250. Among the commands in the set of commands that can be sent by controller 250 are the write and read commands that are forwarded to the memory array control module 240 upon decoding, and a mode register set command. When the mode register set command is received, command decoder 210 sends a “write MRS register” command to MRS register 220, causing MRS register 220 to be loaded with operational parameters (i.e., memory access parameters), which can be supplied via the address input (or, optionally, the data input). By way of example, the memory access parameters may include the burst length, drive strength, write and read latencies, impedance calibration, and the on die termination state. The configuration specified by the memory access parameters loaded into MRS register 220 is supplied to memory array control module 240, which configures the write and read operations accordingly. Once the memory access parameters are loaded, all subsequent write and read operations must be performed in accordance with the memory access parameters in the MRS register. If it becomes necessary to write or read with different parameters, operation of the memory device must be temporarily halted to clear out the pipeline of data, send a mode register set command, and re-write the contents of the MRS register, resulting in a delay of several cycles.

Referring to FIG. 3, a memory device 300 according an exemplary embodiment can be implemented to operate with user-defined commands that are encoded to specify operations to be performed (e.g., write, read, or terminate) and at least some of the memory access parameters to be used in performing the operation (e.g., burst length and write/read latency). The architecture depicted in FIG. 3 is a conceptual diagram illustrating major functional units, and does not necessarily illustrate physical relationships. Memory device 300 can be, for example, a dynamic random access memory (DRAM), such as a double data rate (DDR) synchronous DRAM (SDRAM), or a reduced latency DRAM (RLDRAM). However, it will be understood that memory device 300 can represent virtually any type of memory device, and the invention is not limited to any particular type of memory device or hardware configuration.

Memory device 300 includes a command decoder 310, a mode module 320, a memory array 330, a memory array control module 340, and an address latch/counter 350. Command decoder 310 receives operational commands from a controller 360 in the form of three control bits: CMD[0], CMD[1], and CMD[2], where combinations of the values of control bits correspond to particular commands. Mode module 320 is essentially an expanded mode register or set of registers that stores the memory access parameters and operational configurations for accessing memory array 330. As will be described in detail, sets of encoded commands defined by a user can be programmed into mode module 320.

Address latch/counter 350 receives the address input and supplies address information for reading and writing to memory array 330. Memory array 330 also receives data to be written to the memory array via the data input. Data read from memory array 330 is supplied on the data output. The input and output signals sent and received via the address and data lines are typically multi-bit signals (e.g., address and data words). As shown in FIG. 3, the address input is also coupled to command decoder 310 and mode module 320 for supplying information used in programming mode module 320. The command decoder 310, mode module 320, and address/latch counter 350 can be distinct units or modules or can be implemented jointly in a common operational module or unit. Optionally, at least certain operations performed by these modules can be performed via software.

Controller 360 includes a memory management module 370 and a command generator module 380. These modules may be implemented in software, hardware or combinations thereof and may be implemented as a single operational module, unit or process, or as a plurality of distinct modules, units or processes. Memory management module 370 is responsible for communicating with one or more processors supported by memory device 300 and managing control of and access to memory device 300 (e.g., determining the sequence of commands that must be sent to the memory device to store and retrieve data efficiently, controlling memory access parameters, etc.) based on the memory needs of the processor(s) or system that the memory device is supporting. Those skilled in the art will recognize that the particular configuration of memory management module 370 depends upon the system architecture and the requirements of the types of applications to be handled by the system. The command generator module 380 essentially generates the command signal or control bits that are sent to memory device 300 to carry out certain operations based on the operations specified by memory management module 370.

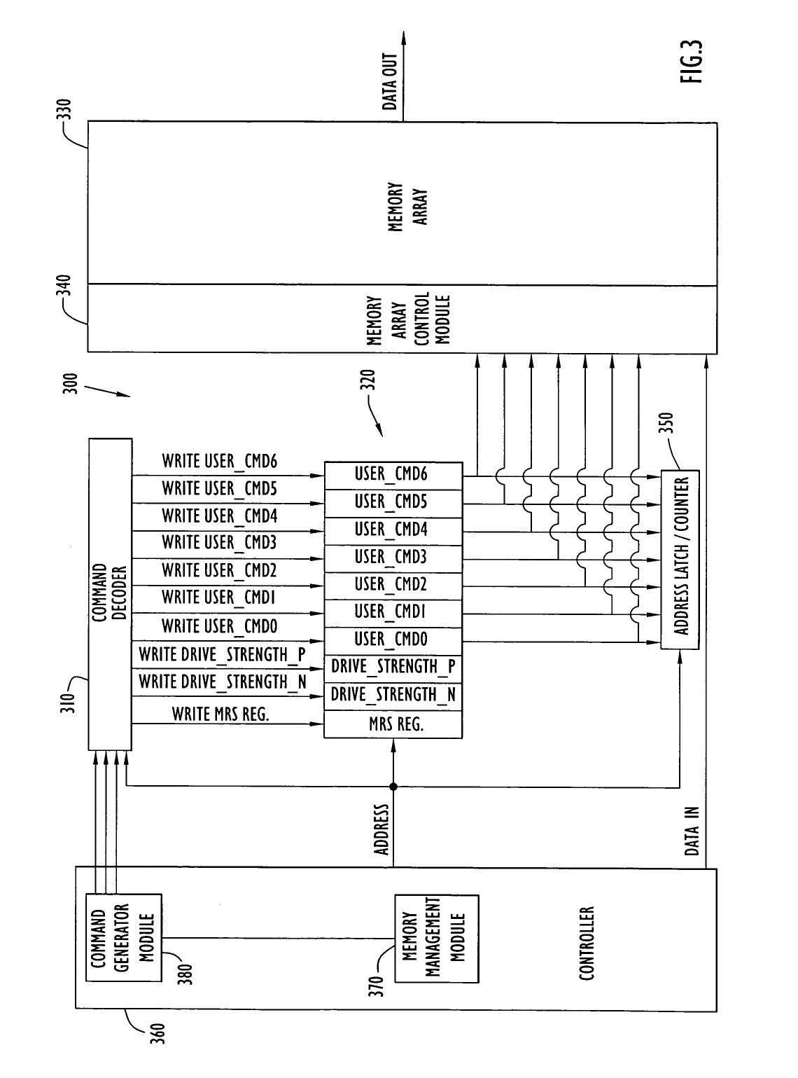

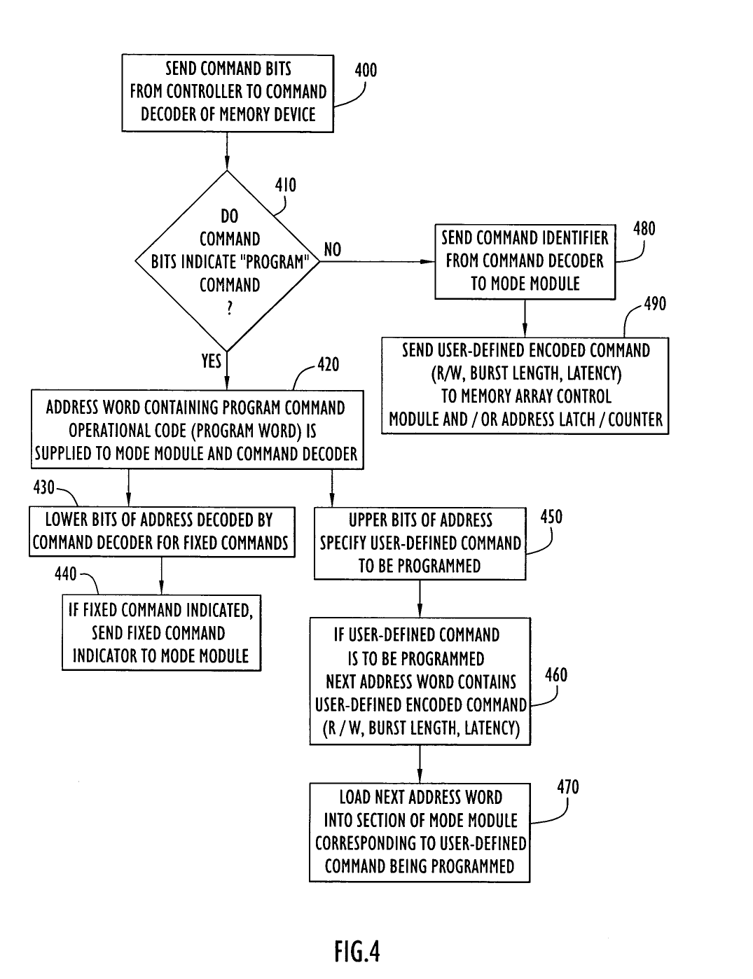

Operation of memory device 300 is described in connection with the flow diagram of FIG. 4. Controller 360 sends commands bits CMD[2:0] to command decoder 310 in order to instruct memory device 300 to perform a particular operation (operation 400). By using three command pins, up to eight commands (commands 0 through 7) can be encoded, as shown in the table of FIG. 5. The use of three control bits to provide eight commands is an example only. It will be understood that any suitable number of control bits and commands can be used. The decoded commands 1 through 7 respectively correspond to seven user-definable commands (user_cmd0 through user_cmd6), which can be write or read commands, for example, that are performed in accordance with the address supplied via the address input. The command 0 (i.e., bits 000), hereinafter denoted as the program command, can be used to program control for the memory device and program the user-defined commands (in general any of the commands can be a program command; the command 000 is only an example). Specifically, the program command indicates that a fixed command is to be performed or that one of the seven user-definable commands is to be programmed as specified in an operational code (OP_CODE) contained in the input address word. Once the desired set of user-defined commands is programmed, normal operation can begin using the user-defined commands.

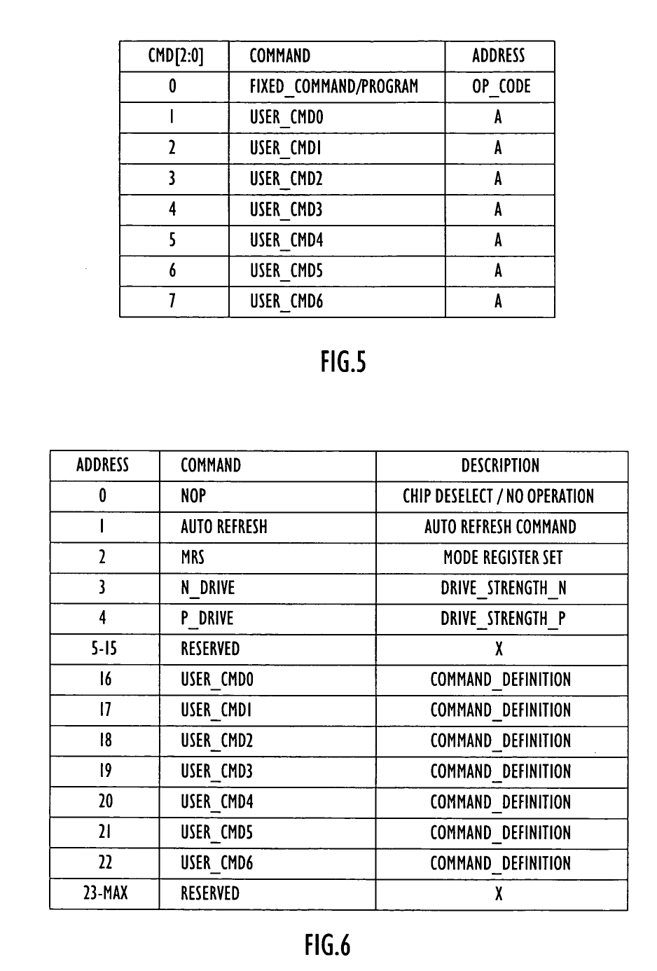

At initialization of memory device 300 or when reprogramming is desired, a user can program the user-defined commands into mode module 320. Referring to operation 410 in FIG. 4, if the command bits indicate a program command (i.e., bits 000 are received), the address containing the program command operational code is supplied to command decoder 310 and mode module 320 (operation 420). While the address word is used in this example to supply the program command and command definitions, it will be understood that this information can be supplied to the control decoder and mode module using any suitable bus. Thus, for example, the data input could be used instead of or in combination with the address input. An example of how the address word can be configured to contain a program command operational code (also denoted here as simply the “program word”) is illustrated in the table of FIG. 6. The lower bits of the address, such as bits 0 through 4, can contain fixed commands. For example, address bit 0 can correspond to a chip deselect/no operation (NOP) command, address bit 1 can correspond to an auto refresh command, address bit 2 can correspond to a mode register set (MRS) command, address bit 3 can correspond to a drive strength N set command (N_DRIVE), and address bit 4 can correspond to a drive strength P set command (P_DRIVE). The upper bits of the address word can be configured to specify which of the seven user-defined commands is to be programmed. For example, bits 16 though 22 can respectively indicate which command definition of user-defined commands 0 through 6 is to be received in the next address word.

In the memory device configuration shown in FIG. 3, when the program command (000) is received by command decoder 310, command decoder 310 analyzes the lower bits of the address word to determine whether a fixed command is to be performed (operation 430 in FIG. 4). If one of the fixed commands is indicated by the lower bits of the address word, command decoder 310 sends a command on the appropriate command line to mode module 320 indicating that the fixed command is to be performed (operation 440 in FIG. 4). For example, when the program command (000) is received and address bit 2 is high (H), a mode register set command is indicated. Command decoder 310 then sends a “write MRS register” command to mode module 320. Mode module 320 includes an MRS register that stores certain memory access parameters, such as: the delayed lock loop (DLL) state (i.e., DLL enabled or DLL disabled); whether the address is multiplex or non-multiplex; the impedance calibration; and on die termination state (enabled/disable). Typically, the memory access parameters stored in the MRS register are those that configure the memory chip for all operations and would seldom, if ever, vary from one read or write command to another. If sufficient bits are available in the address word, an encoded set of bits in the address word can be used to specify these memory access parameters, and the encoded set of bits is loaded into the MRS register, resulting in a single cycle mode register set. Alternatively, an encoded set of bits can be encoded in the address pins on the second cycle (i.e., the next address word) for a two-cycle mode register set command.

An example of MRS encoding of four address pins is shown in FIG. 7. The address bits are labeled 0-3, which suggests a two-cycle mode register set; however, any set of address bits can be used, and the example is equally applicable to single or two-cycle MRS commands. When address bit 0 is a logical 0, DLL is disabled, and when address bit 0 is a logical 1, DLL is enabled. When address bit 1 is a logical 0, the address is non-multiplexed, and when address bit 1 is a logical 1, the addressed is multiplexed. When address bit 2 is a logical 0, 50 ohm internal calibration is used, and when address bit 2 is a logical 1, an external calibration resistor is used. Finally, when address bit 3 is a logical 0, on die termination is disabled, and when address bit 3 is a logical 1, on die termination is enabled. The other fixed commands, such as drive strength N and drive strength P, can be encoded in a similar manner, as suggested by the write drive strength command lines from command decoder 310 to mode module 320. As with the memory access parameters stored in the MRS register portion of the mode module, mode module 320 can include a register(s) or a portion of a register for storing the drive strength settings. By using the program command to point to the address word for these less time-critical commands, the remaining seven commands decoded from the input control bits can be reserved for seven user-defined commands. This approach advantageously allows a greater overall number of commands (fixed and programmable) to be used while minimizing the number of pins requires to support control commands.

As suggested by the write_user_cmdx lines extending from command decoder 310 to mode module 320 in FIG. 3, when the program command (000) is received by command decoder 310 and one of the upper bits of the address word indicates that a user-defined command is to be programmed, command decoder 310 sends a corresponding write command to mode module 320 indicating that one of the user-defined commands is to be programmed (operation 450 in FIG. 4). Controller 370 sends in the next address word a user-defined encoded command that defines the command to be programmed, i.e., the command definition (operation 460). This next address word is loaded into a register or portion of mode module 320 corresponding to the user-defined command being programmed (operation 470).

The use of a single program command that points to a program word or operational code whose lower bits correspond to fixed commands and whose upper bits correspond to user-defined commands to be programmed is just one possible configuration for implementing programming of user-defined commands. For example, if the number of available commands permits, two separate control commands could be used for the fixed commands and for programming the user-defined commands, respectively. In this case, one command (e.g., 000) could be used to indicate that a fixed command is specified in the address word, and another command (e.g., 001) could be used to indicate that the user-defined command to be programmed is specified in the address word. This scheme may potentially support inclusion of the encoded information within the same address word, making one cycle MRS commands and one cycle programming of user-defined commands possible. If a large enough command set is available (e.g., if four or five command bits are used), it may be possible to leave all of the fixed commands in the main command set, so that use of an address word to specify the fixed commands become unnecessary. In this case, a single program command could be used solely for programming user-defined commands, and the program command operational code in the address word would be likewise be devoted solely to programming user-defined commands. Further, the data input can be used instead of or in combination with the address line to supply information to support mode module encoding.

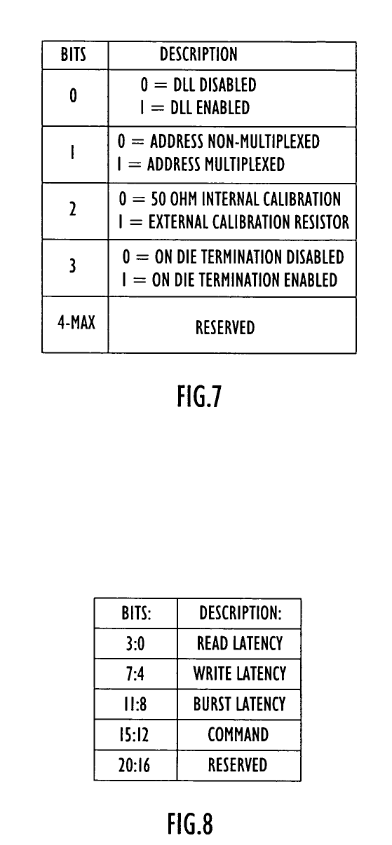

Advantageously, certain memory access parameters, such as the read latency, write latency, burst length, and the command itself (write, read, or terminate) can be defined by the user within the command definition, such that each user-defined command can have a unique burst length and latency. Thus, for example, user-defined command 0 can be a read or a write command, with a specified burst length and read/write latency. User-defined command 1 can also be a read or write command, with its own specific burst length and latency, etc. The bits of the address word containing the command definition can be encoded in the manner shown in the table of FIG. 8. It will be appreciated that this encoding is merely one example of how encoding could be accomplished. In the example shown in FIG. 8, the first four bits of the address containing the command definition (bits 0 through 3) are encoded with the read latency, and the next four bits (bits 4 through 7) are encoded with the write latency. The following four bits (bits 8 through 11) are encoded with the burst length, and finally the next four bits (bits 12 through 15) are encoded with the command itself. Higher bits can be reserved.

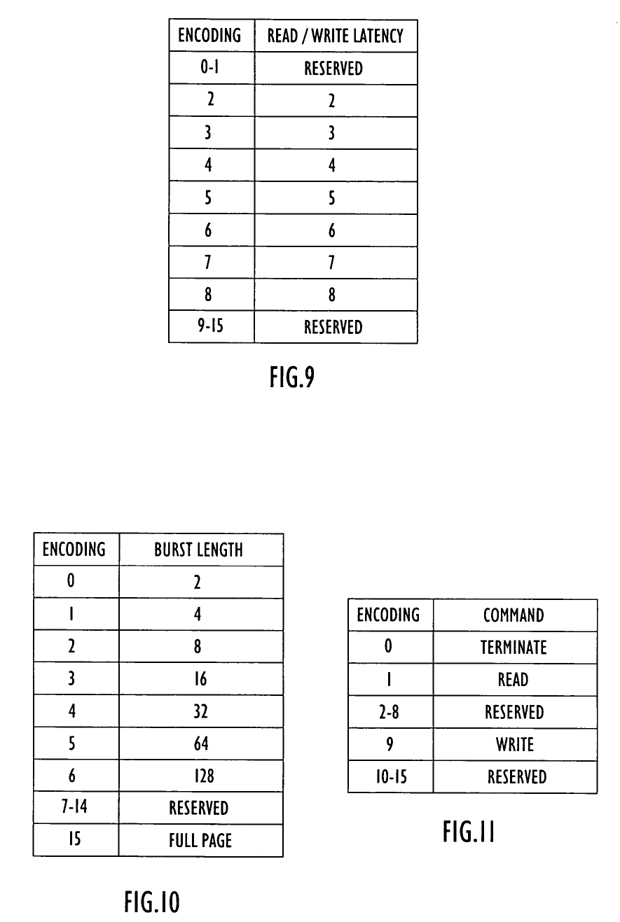

An example of how to encode each of the four bits of the command definition respectively associated with the read and write latencies is shown in the table of FIG. 9 (i.e., the example shown in FIG. 9 applies both to the four bits [3:0] for the read latency and the four bits [7:4] for the write latency). The combination of the four binary bits provides a hexadecimal number having sixteen possible decimal values, 0 to 15 (or 0000 to 1111). A value of the four bits equaling 2 (i.e., 0010) corresponds to a read/write latency of 2. Likewise, bit values of 3 (0011) through 8 (1000) can correspond to read/write latencies of 3 through 8, respectively. The remaining hexadecimal values can be reserved.

An example of how to encode the burst length using four bits [11:8] of the command definition is shown in the table of FIG. 10. Again, the combination of the four binary bits provides a hexadecimal number having sixteen possible decimal values, 0 to 15. Values 0 (0000) to 6 (0110) can correspond to burst lengths of 2, 4, 8, 16, 32, 64, and 128 data words, respectively. Value 15 (1111) can correspond to a full page burst length. The remaining hexadecimal values can be reserved.

An example of how to encode the operational command using four bits [15:12] of the command definition is shown in FIG. 11. Hexadecimal value 0 (0000) can correspond to the terminate command, value 1 (0001) can correspond to the read command, and value 9 (1001) can correspond to the write command. The remaining hexadecimal values can be reserved. The terminate command provides additional flexibility in writing and reading operations. Specifically, the terminate command causes a write or a read that is in progress to be immediately terminated on the fly. Thus, for example, if the burst length is set to large value, such as the full page, burst accesses of arbitrarily shorter lengths can be achieved by appropriately selecting the timing of a subsequent terminate command.

It will be understood that the number bits and the particular encoding scheme values described in connection with FIGS. 9-11 are only one specific example of how the latencies, burst length and commands can be encoded. In general, the command definition can be encoded using any suitable number of bits for each field and any suitable encoding scheme, wherein certain bit combinations correspond to certain latencies, burst lengths and commands.

In this case, each user-defined command stored in mode module 320 includes not only the read or write (or terminate) command but also the burst length and read/write latency associated with the read/write command. With up to seven such user-defined commands (in the example here), a variety of different read and write commands can be specified with the command set decoded by the command decoder. Using encoded commands offers configuration flexibility without having to re-write a mode register each time different memory access parameters are required without any penalty in decoding speed, resulting in scheduling and datum size flexibility on the fly.

In the example provided, the read/write latency and the burst length are memory access parameters that are definable within the command definition. However, it will be understood that the invention is not limited to embodiments in which only this specific set of memory access parameters is contained within the command definition. More generally, any memory access parameter used to configure a memory device that can be specific to certain commands can be encoded into the command definitions if useful in a particular context or architecture.

Once the user-defined commands have been encoded, normal operation of the memory device can commence using the command set containing the user-defined commands and the program command. Note that, in the embodiment described, the program command (000) is still used during normal operation (not just for programming the other commands) to command the fixed (non-programmable) commands via the lower bits of the address word. For example, an auto refresh is commanded by sending the program command on the command bits and concurrently setting address bit 1 to high. Likewise, the no operation command (NOP) is commanded by sending the program command and concurrently setting the address 0 bit to high.

The read, write and terminate commands encoded into user-defined commands 0 through 6, are executed by sending the appropriate combination of command bits to command decoder 310, which sends the corresponding user-defined command to mode module 320 (operation 480 in FIG. 4). Mode module 320 then sends the encoded information for the selected user-defined command to the address latch/counter 350 and to memory array control module 340 to cause the command to be carried out (operation 490). Specifically, during normal operation, the address word is supplied to the address latch/counter 350, which latches the input address which points to the memory location where the read or write operation is to begin and performs a counter function that supplies a sequence of addresses to memory array 330 beginning with the input address, such that a succession of words is read from memory array 330 and supplied on the data output.

As suggested by the lines extending from mode module 320 to both address latch/counter 350 and memory array control module 340, certain information in the user-defined command can be directed to address latch/counter 350, while other information in the user-defined command can be directed to memory array control module 340, depending on how these modules are configured and share the tasks associated with accessing the memory. For example, the burst length and read/write latency information can be received by address latch/counter 350, while the command itself (read or write) can be received by memory array control module 340. Alternatively, the latency information could be sent to memory array control module 340 if this module is responsible for implementing the latency. Alternatively, all of the information (command, burst length and latency) could be sent to the memory array control module 340, in which case memory array control module 340 would be responsible for all aspects of controlling the memory access, and address latch/counter 350 would simply latch and increment the address without providing control functionality.

Note that address latch/counter 350 provides a conceptual sense of accessing a sequence of addresses based off a start address and a particular burst length. It will be understood, however, that the address sequencing can be implemented in any of a variety of ways, and the invention is not limited to implementations involving a separate latch/counter mechanism, such as that shown conceptually in FIG. 3. For example, the functions of the address latch/counter could be fully integrated into the memory array control module.

The usefulness of user-defined commands can be appreciated by considering a few practical scenarios. Consider the situation where two or more processors sharing access to a memory device have different techniques or algorithms for addressing the memory device, such that different burst lengths and read/write latencies are optimal for the different processors. With user-defined commands, a certain set of user-defined commands can be optimally configured to support one processor, while another set of user-defined commands can be optimally configured to support another processor. With sufficient command bits and registers, the access to the memory device can be tailored for every device that may access the memory device. Switching among the various different access mode can be performed on the fly, such that switching from accessing the memory device with one set of memory access parameters (e.g., burst length and latency) to accessing the memory device with a different set of memory access parameters can be performed without changing the contents of a register or storage module that stores memory access parameters for controlling how the memory device is accessed. This capability greatly reduces the number of controller states and overall controller complexity and improves memory access flexibility and speed.

In the context of networking applications, when using a SIO mode of operation, one-hundred percent bus utilization typically cannot be achieved with the lowest row cycle time (tRC) in a typical dynamic random access memory (DRAM) architecture while maintaining a balanced read/write pattern commonly found in networking applications. By permitting the user to define commands that allow the read and write latencies to vary, the combination of low tRC and 100% bus utilization can be achieved for common networking applications while using SIO mode.

While the foregoing example involves a controller that controls a memory device with three control bits that decode in a specific manner into a particular command set, the invention is not limited to any specific number or type of control bits, decoding scheme or command set. In general, the technique can be implemented using any control or command scheme that permits the use of user-defined commands in which the commands are encoded with access-specific memory access parameters such as, for example, burst length and read/write latencies. The described memory device and command scheme is also not limited to any particular memory array architecture or addressing scheme. Thus, for example, the technique is equally applicable in memory devices that increment parts of the address for write and read commands.

Having described preferred embodiments of new and improved memory device controlled with user-defined commands, it is believed that other modifications, variations and changes will be suggested to those skilled in the art in view of the teachings set forth herein. It is therefore to be understood that all such variations, modifications and changes are believed to fall within the scope of the present invention as defined by the appended claims. Although specific terms are employed herein, they are used in a generic and descriptive sense only and not for purposes of limitation.

1. A method of accessing a memory device using a plurality of user-defined commands, comprising:
(a) providing a set of commands for controlling access to the memory device, wherein the set of commands includes the plurality of user-defined commands;
(b) storing in the memory device a set of memory access parameters associated with each user-defined command, wherein each set of memory access parameters includes at least one memory access parameter; and
(c) accessing the memory device using the user-defined commands, wherein each memory access commanded by a user-defined command is controlled in accordance with the set of memory access parameters associated with the user-defined command.

2. The method of claim 1, wherein the memory access parameters include a burst length.

3. The method of claim 1, wherein the memory access parameters include at least one of a read latency and a write latency.

4. The method of claim 1, wherein the set of commands further includes a program command for programming the user-defined commands into the memory device.

5. The method of claim 4, further comprising:
(d) identifying from an operational code a user-defined command to be programmed in response to receiving the program command.

6. The method of claim 5, wherein (b) further includes:
storing in the memory device a command definition associated with the user-defined command identified from the operational code, wherein the command definition includes a memory access command and the set of memory access parameters.

7. The method of claim 6, wherein the memory access command is one of: a read command, a write command, and a terminate command.

8. The method of claim 6, wherein the set of memory access parameters includes a burst length and at least one of a read latency and a write latency.

9. The method of claim 5, wherein the operational code associated with the program command is received by the memory device via an address bus.

10. The method of claim 5, wherein the operational code associated with the program command is received via a data bus.

11. The method of claim 4, further comprising:
(d) identifying from an operational code a non-programmable command to be executed in response to receiving the program command.

12. The method of claim 11, wherein the non-programmable command is one of: an auto refresh command, a mode register set command, a no operation command, and a drive strength setting command.

13. A method of programming a memory device to support a plurality of user-defined commands, comprising:
sending a program command from a controller to the memory device, wherein the program command indicates that a user-defined command is to be programmed in the memory device;
sending an operational code associated with the program command from the controller to the memory device, wherein the operational code indicates which of the plurality of user-defined commands is to be programmed;
sending a command definition from the controller to the memory device, wherein the command definition includes a memory access command and at least one memory access parameter; and
storing the command definition in the memory device such that the command definition is associated with the user-defined defined command indicated by the operational code.

14. The method of claim 13, wherein the memory access command is one of a read command, a write command, and a terminate command.

15. The method of claim 13, wherein the at least one memory access parameter includes a burst length.

16. The method of claim 13, wherein the least one memory access parameter includes at least one of a read latency and a write latency.

17. A method of accessing a memory device using a plurality of user-defined commands, comprising:
(a) providing a set of commands for controlling access to the memory device, wherein the set of commands includes the plurality of user-defined commands and a program command for programming the user-defined commands into the memory device;
(b) programming the user-defined commands by storing command definitions associated with the user-defined commands in the memory device in response to receipt of program commands, wherein each of the command definitions comprises a memory access command and a set of memory access parameters including a burst length and at least one of a read latency and a write latency; and
(c) accessing the memory device using the user-defined commands, wherein each memory access commanded by a user-defined command is controlled in accordance with the set of memory access parameters associated with the user-defined command.

18. The method of claim 17, further comprising:
(d) sending with each program command an operational code, wherein the operational code includes a first set of bits that indicate which, if any, of the user-defined commands is to be programmed via the command definition and a second set of bits that indicate which, if any, of a set of non-programmable commands is to be executed.

19. The method of claim 18, wherein the set of non-programmable commands includes at least one of: an auto refresh command, a mode register set command, a no operation command, and a drive strength setting command.

20. A method of accessing a memory device, comprising:
(a) providing a set of commands for controlling access to the memory device, wherein the set of commands includes a plurality of user-defined commands that are programmable in the memory device and at least one additional command for controlling the memory device with a non-programmable command;
(b) accessing the memory device using the user-defined commands, wherein each memory access commanded by a user-defined command is controlled in accordance with a set of memory access parameters associated with the user-defined command; and
(c) executing a non-programmable command in response to receipt of the at least one additional command, wherein the non-programmable command is specified in an operational code received in connection with the at least one additional command.

21. The method of claim 20, wherein the non-programmable command is one of: an auto refresh command, a mode register set command, a no operation command, and a drive strength setting command.

22. A memory device controllable with user-defined commands, comprising:
a memory array accessible for reading and writing data therein;
a command module that receives commands for controlling access to the memory array, wherein a set of commands for controlling access to the memory array includes a plurality of user-defined commands; and
a mode module that stores command definitions respectively associated with the user-defined commands, wherein each command definition includes a memory access command and at least one memory access parameter, and wherein each memory array access commanded by a user-defined command is controlled in accordance with the at least one memory access parameter in the command definition associated with the user-defined command.

23. The memory device of claim 22, wherein the memory access command is one of a read command, a write command, and a terminate command.

24. The method device of claim 22, wherein the at least one memory access parameter includes a burst length.

25. The memory device of claim 22, wherein the least one memory access parameter includes at least one of a read latency and a write latency.

26. The memory device of claim 22, wherein the set of commands further includes a program command for programming the user-defined commands into the mode module, and wherein the command module commands the mode module to program a user-defined command in response to receipt of the program command.

27. The memory device of claim 26, wherein the command module commands the mode module to program a user-defined command specified by an operational code received in connection with the program command.

28. The memory device of claim 27, wherein the operational code is received by the command module via an address bus.

29. The memory device of claim 27, wherein the operational code is received by the command module via a data bus.

30. The memory device of claim 22, wherein the set of commands further includes an additional command for controlling the memory device with a non-programmable command.

31. The memory device of claim 30, wherein the non-programmable command is specified in an operational code received by the command module in connection with the additional command.

32. The memory device of claim 30, wherein the non-programmable command is one of: an auto refresh command, a mode register set command, a no operation command, and a drive strength setting command.

33. The memory device of claim 22, further comprising:
a memory array control module coupled to the memory array, that receives memory access commands from the mode module in response to receipt of a user-defined command, wherein the memory array control module controls access to the memory array in accordance with the memory access parameters associated with the user-defined command.

34. The memory device of claim 33, further comprising:
an address latch/counter module that receives an input address associated with a user-defined command and supplies addresses to the memory array control module during memory access in accordance with the memory access parameters associated with the user-defined command.

35. The memory device of claim 22, wherein the memory device is a dynamic random access memory (DRAM).

36. A memory device controllable with user-defined commands, comprising:
means for storing data that is accessible for reading and writing data therein;
means for processing input commands for controlling access to the means for storing data, wherein a set of commands for controlling access to the means for storing data includes a plurality of user-defined commands; and
means for storing command definitions respectively associated with the user-defined commands, wherein each command definition includes a memory access command and at least one memory access parameter, and wherein each memory array access commanded by a user-defined command is controlled in accordance with the at least one memory access parameter in the command definition associated with the user-defined command.

37. The memory device of claim 36, wherein the memory access command is one of a read command, a write command, and a terminate command.

38. The memory device of claim 36, wherein the at least one memory access parameter includes a burst length.

39. The memory device of claim 36, wherein the least one memory access parameter includes at least one of a read latency and a write latency.

40. The memory device of claim 36, wherein the set of commands further includes a program command for programming the user-defined commands into the means for storing command definitions, and wherein the means for processing input commands commands the means for storing command definitions to program a user-defined command in response to receipt of the program command.

41. The memory device of claim 40, wherein the means for processing input commands commands the means for storing command definitions to program a user-defined command specified by an operational code received in connection with the program command.

42. The memory device of claim 41, wherein the operational code is received by the means for processing input commands via an address bus.

43. The memory device of claim 41, wherein the operational code is received by the means for processing input commands via a data bus.

44. The memory device of claim 36, wherein the set of commands further includes an additional command for controlling the memory device with a non-programmable command.

45. The memory device of claim 44, wherein the non-programmable command is specified in an operational code received by the means for processing input commands in connection with the additional command.

46. The memory device of claim 44, wherein the non-programmable command is one of: an auto refresh command, a mode register set command, a no operation command, and a drive strength setting command.

47. The memory device of claim 36, further comprising:
means for controlling the means for storing data that receives memory access commands from the means for storing command definitions in response to receipt of a user-defined command, wherein the means for controlling the means for storing data controls access to the means for storing data in accordance with the memory access parameters associated with the user-defined command.

48. The memory device of claim 36, wherein the memory device is a dynamic random access memory (DRAM).

49. A controller for controlling a memory device, comprising:
a memory management module that manages access to the memory device; and
a command generator module that generates commands for accessing the memory module in accordance with the memory management module, wherein the commands include a plurality of user-defined commands and a program command for programming the user-defined commands into the memory device, and wherein the controller sends to the memory device a command definition associated with a user-defined command to be programmed, the command definition including a memory access command and at least one memory access parameter.

50. The controller of claim 49, wherein the controller sends to the memory device an operational code indicating which user-defined command is to be programmed in connection with a program command.

51. The controller of claim 49, wherein the memory access command is one of a read command, a write command, and a terminate command.

52. The controller of claim 49, wherein the at least one memory access parameter includes a burst length.

53. The controller of claim 49, wherein the least one memory access parameter includes at least one of a read latency and a write latency.
